(19) United States
(12) Patent Application Publication
(10) Pub. No.: US 2025/0206541 A1
(43) Pub. Date: Jun. 26, 2025

(54) CONVEYOR BELT FOR AGRICULTURAL MACHINES

(71) Applicant: ARNOLD JÄGER HOLDING GMBH, Hannover (DE)

(72) Inventors: Sebastian JÄGER, Hannover (DE); Nick BAAKE, Lehrte/Immensen (DE)

(21) Appl. No.: 18/990,108

(22) Filed: Dec. 20, 2024

(30) Foreign Application Priority Data
Dec. 22, 2023 (EP) 23219756.6

(51) Int. Cl. B65G 15/44; B65G 15/34; B65G 15/46

(52) U.S. Cl. CPC B65G 15/44; B65G 15/34; B65G 15/46

(57) ABSTRACT

The present disclosure relates to a conveyor belt for transporting goods to be conveyed in a transport direction, comprising:

an entrainment region comprising a circumferential reinforced planar element with an outer side to support the goods to be conveyed;

at least two tension areas running around the conveyor belt, where the planar element extends between the tension areas; and

multiple entrainment slats extending on the outer side of the planar element in the transverse direction and being connected with the planar element.

The present disclosure provides that at least one sewn connection is formed

between at least one of the entrainment slats and the planar element, and/or

circumferential around the conveyor belt in at least one of the tension areas.

### PRIORITY CLAIM

This application claims priority to European Patent Application No. EP23219756.6, filed Dec. 22, 2023, which is expressly incorporated by reference herein.

### BACKGROUND

The present disclosure relates to a belt, and particularly to a conveyor belt. More particularly, the present disclosure relates to a conveyor belt for agricultural machines.

### SUMMARY

According to the present disclosure, a conveyor belt for agricultural machines, in particular, in a draper belt for transporting goods to be conveyed in a direction of transport, a sewn connection is made, more specifically,

Variant 1: in the transverse direction (essentially perpendicular to the transport direction) extending between at least one entrainment slat or entrainment fin and a planar element in an entrainment region, to connect the at least one entrainment slat with the planar element, and/or

Variant 2: fully circumferential (in the circumferential direction) around the conveyor belt in at least one tension area which serves to absorb tension forces upon driving the conveyor belt.

Thus, the conveyor belt according to the preamble comprises at least one such entrainment region made of a preferably fully circumferential planar element, the planar element comprising a polymer layer including at least one reinforcement inlay, e.g., a fabric layer or a fleece layer/web layer (non-woven), where, preferably, a rubberized outer side (upper side) of the planar element is provided, in particular, in the entrainment region for the goods to be conveyed to rest upon and to be entrained. Hereby, the planar element is joined to be endless at will. Preferably, the at least one reinforcement inlay of the planar element is covered on both sides in the entrainment region by the polymer layer of the planar element or merely on the inside or merely on the outside by the polymer layer of the planar element.

Hereby, it may further be provided for rolling inhibiting structures or, respectively, bars to be applied onto the outside (upper side) of the planar element at least in the entrainment region which slightly project away from the outside and are arranged evenly distributed across the entire surface, for example, offset in relation to one another. The rolling inhibiting bars each have, for example, a rounded shape, for example, crescent shape, or an angular shape, for example, triangular shape, zigzag shape, diamond shape or U shape, each opening in a direction perpendicular to the transport direction. Hereby, the rolling inhibiting bars serve to retain the goods to be conveyed resting thereon in the entrainment region, in particular, in the case of a conveyor belt inclined in the transverse direction. Then, the rolling inhibiting bars also opening in the transverse direction will stop the goods to be conveyed rolling off along the slope in the transverse direction and prevent it from falling off conveyor belt.

Further, at least two, preferably fully circumferential tension areas each made of at least one polymer layer and at least one reinforcement inlay, e.g., a fabric layer or a fleece layer (non-woven), are provide, where the planar element extends in-between these tension areas. The planar element may be connected with the at least two tension areas circumferential on both sides by the sewn joint (according to Variant 2). The tension areas too are joint at will to be endless. Preferably, a tensile strength of the entrainment region in the direction of transport is smaller than a tensile strength of the respective tension area in the direction of transport because the tension area is provided to drive the conveyor belt and therefore subjected to higher tension loads, in particular, in the direction of transport.

Preferably, it may also be provided that the higher tensile strength in the direction of transport in the respective tension area is created in that
the at least one reinforcement inlay in the respective tension area is made from a material having a higher tensile strength than the material of the at least one reinforcement inlay in the entrainment region, and/or
the at least one polymer layer in the respective tension area is made from a material having a higher tensile strength than the material of the at least one polymer layer in the entrainment region. This is a simple to implement option of increasing the tensile strength.

There also may be provided more than one entrainment region or, respectively, more than one planar element and therefore also more than one tension area, in the case of a broad conveyor belt supported on drive roller and pulleys not only on the outside but also in the middle.

Further, multiple entrainment slats are provided, the entrainment slats extending on the outside of the planar element in the transverse direction, and possibly even project beyond that into the tension areas, and being connected with the planar element in the entrainment region at least between the tension areas, for example, via a sewn connection (according to Variant 1). Hereby, a (sewn) connection with the tension areas may be formed even when the ends of the entrainment slats project into these.

Hereby, preferably, it is provided for the at least one entrainment slat to be reinforced by a rod extending along the entrainment slat, preferably a rod made of glass fiber reinforced plastic or metal, the rod preferably having a round cross-section. Other cross-sections are also possible, however.

Moreover, preferably, at least one fully circumferential wedge bar is provided, where the at least one wedge bar extends on an inner side (lower side) of the respective tension area, where, preferably, the wedge bar too may be connected with the tension areas fully circumferential by means of the sewn connection (according to Variant 2). Hereby, the inner side of the tension area together with an inner side of the planar element co-forms an inner side of the conveyor belt and therefore lies opposite the outer side of the planar element.

Thus, the single general concept is to connect individual or even all components of the conveyor belt, i.e., at least one wedge bar (according to Variant 2) and/or at least one entrainment slat (according to Variant 1) and/or the at least one tension area from at least one polymer layer and at least one reinforcement inlay (according to Variant 2), via a sewn connection to the respectively adjacent component, so as to improve or to expand the characteristics (higher tensile strength, robustness, resilience) and/or functions (entrainment function, guide function) of the conveyor belt.

This alone brings about several advantages: for example, there is no need for a complex and/or lengthy connecting process such as glueing, welding, vulcanizing, molding and the costly tools associated therewith for connecting the respective component with the entrainment region and/or the tension area. By means of a sewn connection it is possible to create a highly durable and robust or, respectively, high-tensile transition between the respective component of the conveyor belt, while a seam can be made with little effort.

Also, in the case of an adaptation of the configuration of the conveyor belt needed by an adaptation of dimensions or positions of the respective components, the sewn connection can be adapted in a simple and flexible manner. Moreover, the material does not necessarily require adjustment to a heat treatment to create the connection.

In principle, however, it may nevertheless be provided that
the components that are not connected to one another by a sewn connection, instead
or the components that are connected to one another by a sewn connection, additionally are connected to one another via a substance-to-substance bond, for example, by vulcanization or glueing, to create the respective connection or, respectively, to strengthen it, or, respectively, secure it, for example, in the case of exceptionally high loads.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in

which:

FIG. 1 shows a conveyor belt circulating on a drive roller and pulley;

FIGS. 2A and 2B show the conveyor belt according to FIG. 1 in perspective detail views in various embodiments of a tension area;

FIGS. 3A and 3B show the conveyor belt according to FIG. 1 in perspective detail views in further embodiments with a separate tension member in the tension area;

FIGS. 4A and 4B show various embodiments of wedge bars on an inner side of the tension area of the conveyor belt according to FIG. 1; and

FIGS. 5A-5F show various embodiments of entrainment slats on an outer side of the conveyor belt according to FIG. 1.

### DETAILED DESCRIPTION

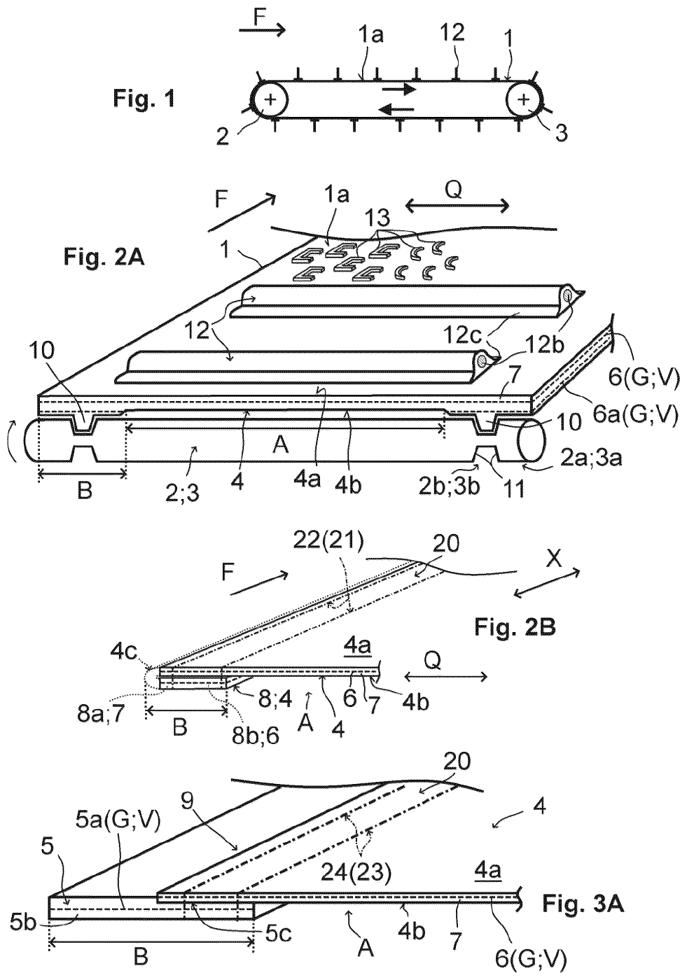

FIG. 1 shows an endless circumferential conveyor belt 1 for agricultural machines circulating on a drive roller 2 and a pulley 3. A circumferential conveyor belt 1 of this type serves, for example, as a sideways transport for light cut material in a cutting unit of a combine harvester or in a mowing unit for lateral placement of the cut material in windrows. Such a conveyor belt 1 is also referred to as stretching band, “draper belt,” “merger belt” or “swather belt.” The respective goods to be conveyed lies on a surface or, respectively, outer side 1a of the conveyor belt 1 and is transported in a transport direction F.

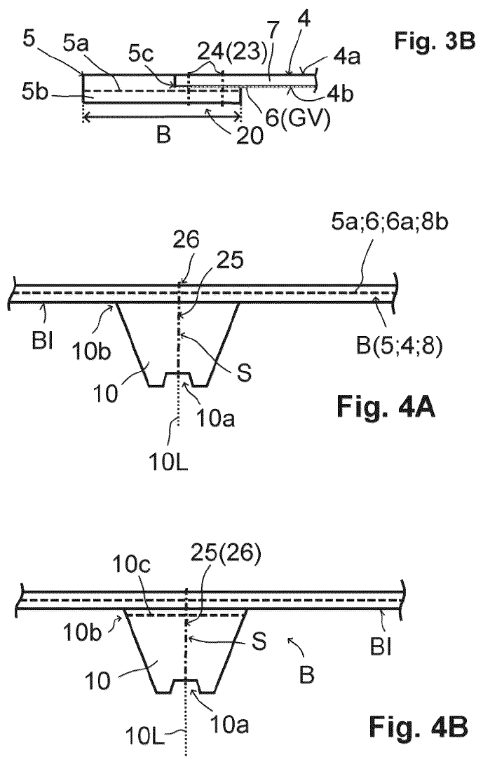

According to FIGS. 2A, 2B, 3A, 3B. the conveyor belt 1 is sub-divided in the transverse direction Q in an entrainment region A and, joining on both sides thereof, tension areas B (shown only on one side in FIGS. 2B, 3A, 3B) which are connected with one another. According to the embodiment in FIGS. 2A and 2B, the entrainment region A directly transitions into the respective tension area B. In this embodiment, the entrainment region A consists of a belt-type planar element 4 a modified structure of which directly transitions into the respective tension area B, as will be illustrated in the following. According to the embodiment in FIGS. 3A, 3B, the entrainment region A also consists of this planar element 4, however, in the respective tension area B a separate belt-type tension member 5 is added to the planar element 4, as described below.

In all embodiments, even multiple entrainment regions A may be provided in the transverse direction Q, where, in that case, a sequence of the regions of B-A-B-A-B ensues, i.e., each entrainment region A is verged on both sides in the transverse direction Q by a tension area B. This is the case, for example, with a very broad conveyor belt 1 with an additional central drive and/or an additional central support.

Here, the belt-type planar element 4 consists of a reinforce polymer, in particular, rubber, where, to that end, in the embodiments shown, the planar element 4 comprises a reinforcement inlay 6 within the entrainment regions A which is embedded in a polymer layer 7 of the planar element 4. Depending on the needs as to (tensile) strength the reinforcement inlay 6 may be a fabric inlay G or a fleece inlay V (“non-woven”).

In the embodiment of FIGS. 2A, 2B and 3A, the reinforcement inlay 6 lies in the entrainment region A in the neutral fiber or, respectively, approximately centrally within the planar element 4, i.e., both an outer side 4a and an inner side 4b of the planar element 4 are each rubberized. In the embodiment according to FIG. 3B, however, the reinforcement inlay 6 also forms the inner side 4b of the planar element 4 at the same time so that this is rubberized only on the outside.

In the entrainment region A of the conveyor belt 1 only little tensile strength is needed because in the entrainment region A the goods to be conveyed merely rests upon and the conveyor belt 1 is carried along and therefore there are no or only little tensile farces acting so that in this region of the planar element 4 a single reinforcement inlay 6, in particular, a single fleece layer V, is sufficient. In contrast here to, the adjacent tension area B of the conveyor belt 1 exhibits a high degree of tensile strength. This is because the conveyor belt 1 is driven via the tension area B, as will be illustrated further in the following, so that this tension areas B of the conveyor belt 1 is subjected to high tension loads in operation.

A high degree of tensile strength can be attained, for example, in that two parallel reinforcement inlays 6, 6a each, arranged on top of one another and spaced apart, are embedded into the planar element 4 in the tension area B. In addition, as shown in the embodiment in FIG. 2A, the reinforcement inlay 6 of the planar element 4 extends beyond the entrainment region A also into the tension area B in which a further additional reinforcement inlay 6a (fleece layer V or fabric layer G) into the polymer layer 7 is embedded running parallel underneath. Thus, the tension area B is reinforced by two reinforcement inlays 6, 6a. Hereby, the additional reinforcement inlay 6a may be configured identical to the reinforcement inlay 6 of the planar element 4, i.e., for example, also as a fleece layer V, or even different, i.e., for example, as a fabric layer G.

To create a high tensile strength in the tension area B it may be alternatively provided to fold over or, respectively, fold back onto itself the edge of the planar element 4 with only one embedded reinforcement inlay 6 (fleece layer V or fabric layer G) so as to form a hem 4c, as indicated by the dotted line in FIG. 2B. Instead, however, it may be provided to dispense with the hem 4c and to use a separate planar rubber strip 8 also consisting of a reinforced cross-linked polymer with, for example, a reinforcement inlay 8b (fleece layer V or fabric layer G) embedded in the polymer layer 8a of the rubber strip 8. This rubber strip 8 is added in the tension area B to the inner side 4b of the planar element 4. In these two embodiments indicated in FIG. 2B, likewise, two reinforcement inlays 6, 6 (folded back) or 6, 8b lie in the tension area B parallel and spaced apart on top of one another, thereby increasing the tensile strength in the tension area B area.

In these embodiments, a connection between the polymer layers 7; 7 (folded back) or 7, 8a reinforced and lying on top of one another in the tension area B can preferably be created in that these polymer layers 7; 8a in the tension area B are seamed together in the longitudinal direction X or, respectively, in the transport direction For, respectively, fully circumferential around the conveyor belt 1. To that end, in the tension area B a first thread 21 penetrates in multiple stitches S the two polymer layers 7; 8a lying on top of one another in such a way that a fully circumferential tension area seam 22 is formed. Depending on the arrangement of the stitches S this may result in various seam shapes of the tension area seam 22. In the example shown, in the tension area B two such tension area seams 22 run parallel with one another to securely hold together the two polymer layers 7; 8a in a laminar manner in the respective tension area B.

Because in the polymer layers 7; 8a lying on top of one another there is always at least one reinforcement inlay 6, 6 (folded over) or 6, 8b, which are also penetrated by the first thread 21 in the stitches S, a high-strength sewn connection is created between the two which is capable of withstanding high loads. If the tension area seam 22 is formed with a correspondingly high tension of the first thread 21, this will also become immersed in the surface of the polymer layers 7; 8a between the stitches S so that in operation the first thread 21 will be largely protected against wear or outside influences.

In order to create a higher tensile strength within the tension area B than within the entrainment regions A, both the embodiment in FIG. 2A as well as the embodiments according to FIG. 2B provide that a number of reinforcement inlays 6, 6a; 8b within the tension area B is higher than a number of reinforcement inlays 6 within the entrainment regions A. In addition, or alternatively here to, the higher tensile strength in the tension area B may be attained in that for a single or multiple reinforcement inlay a material combination of higher tensile strength is chosen. This is shown, by way of example, in the FIGS. 3A and 3B:

Thus, the respective tension area B is formed by an additional belt-type tension member 5 which has merely one reinforcement inlay 5a (fleece layer V or fabric layer G) with a polymer layer 5b. Hereby, the material of the reinforcement inlay 5a and/or the material of the polymer layer 5b are selected such that the tensile strength of the tension member 5 is higher than the tensile strength of the planar element 4 to which this tension member 5 is subsequently attached. In principle however, this can also be attained by means of an additionally attached tension member 5 that has more than one reinforcement inlay 5a.

As in the previous embodiments according to FIG. 2A and FIG. 2B. these additional tension member 5 allow cost savings because only the tension areas B subjected to higher loads must be made from a material having a high strength or, respectively, high tensile strength, rather than the entire conveyor belt 1.

Hereby, the tension member 5 is attached to the planar element 4, as shown in the FIGS. 3A, 3B by way of example. Hereby, the tension member 5 is graduated in the transverse direction Q in that the outer top layer of the polymer layer 5b of the tension member 5 is ablated, at least in part, so as to form a step 5c. Alternatively, also the inner top layer of the polymer layer 5b of the tension member 5 may be ablated (not shown). The edge of the planar element 4 with its inner side 4b (or its outer side 4a) is laid laminar and custom-fit onto the step 5c formed on the outer side (or inner side). Thus, the ablated part of the tension member 5 is “re-filed” by the planar element 4 so that the resilience or tensile strength of the conveyor belt 1 in the tension area B remains high. Hereby, the step 5c is formed such that on the outer side (or inner side) no or only minimal protrusion 9 remains between the tension member 5 and the planar element 4.

This can be arranged in that, as shown in FIG. 3B, the reinforcement inlay 6 of the planar element 4 also forms the inner side 4b of the planar element 4 so that the inner top layer of the polymer layer 7 of the planar element 4 can be dispensed with. Thus, the planar element 4 according to FIG. 3B is thinner compared to the embodiment in FIG. 3A (two-sided rubber lining) so that (ideally) no protrusion 9 remains after mounting onto the step 5c of the tension member 5. Furthermore, it is an achievement that the reinforcement inlay 6 of the planar element 4 lies closer to the level of the reinforcement inlay 5a of the tension member 5 or, respectively, closer to a neutral fiber of the conveyor belt 1 in total, thereby enhancing the overall operation of the conveyor belt 1. Because the inner side 4b of the planar element 4 normally is not subjected to any outside mechanical influence, the reinforcement inlay 6 of the planar element 4 may lie open towards the inside.

The connection between the tension member 5 and the planar element 4 is formed preferably in that these are seamed together in the tension area B in the longitudinal direction X or, respectively, in the transport direction F or, respectively, fully circumferential around the conveyor belt 1. To that end a second thread 23 penetrates the planar element 4 as well as the tension member 5 in the region of the step 5c formed in multiple space-apart stitches S, in such a way that a fully circumferential transition seam 24 is created. Depending on the arrangement of the stitches S this may result in various seam shapes of the transition seam 24. In the example shown, two such transition seams 24 run parallel to one another in the tension area B so as to hold the planar element 4 and the tension member 5 together in a laminar manner.

Because in the planar element 4 and the tension member 5 there is at least one reinforcement inlay 6, 5a each, which are also penetrated by the second thread 23 in the stitches S, a high strength sewn connection is created between the two which can withstand high loads. If the transition seam 24 is created with a correspondingly high tension of the second thread 23 this will also become immersed in the surface of the respective polymer layers 7; 5b between the stitches S so that in operation the second thread 23 will be largely protected against wear or outside influences.

As shown in the previously discussed Figures, a wedge bar 10 is located on an inner side BI of the respective tension area B which extends in the longitudinal direction X or, respectively, in the direction of transport For, respectively, fully circumferential around the entire conveyor belt 1. The two end regions 2a, 3a of the drive roller(s) 2 and/or the pulley(s) 3 each comprise circumferential grooves 2b, 3b, arranged in their cross-section complementary to the wedge bar 10, in which the respective wedge bar 10 can be accommodated in a rotation of the drive roller(s) 2 or, respectively, pulley(s) 3, as indicated in FIG. 2. Thus, the wedge bar 10 serves to guide the conveyor belt 1 in operation on the drive roller(s) 2 and/or pulley(s) 3 which are provided, for example, as barrel rollers, so as to avoid as far as possible any movement of the conveyor belt 1 lying upon it in the transverse direction Q. In order to achieve this only one wedge bar 10 may be provided on the conveyor belt 1, i.e., in only one of the tension areas B.

Because these wedge bars 10 are located on the inner side on the tension areas B additionally reinforced accordingly (as illustrated above), forces acting in the transverse direction Q that appear upon the wedge bar 10 running up against a side frame 11 of the respective groove 2b, 3b can be effectively absorbed and dissipated by the tension area B thereby avoiding increased wear on the edges of the conveyor belt 1. Potentially, even smaller tension forces created by the driving action may be dissipated via the wedge bar 10 in the tension area B.

As shown in FIG. 2A, the wedge bars 10 may be constructed one-piece with the respective tension area B, where, to that end, for example, the wedge bars 10 may be vulcanized or similar together with the planar element 4 in the manufacturing process. However, as shown in FIGS. 4A or 4B, the wedge bars 10 may be attached later to the inner sides of the respective layers of the tension area B, in particular, sewn onto the inner side of the tension area B and/or glued onto the inner side by means of a substance-to substance bond. This allows such a wedge bar 10 to be later attached to the inner side BI of a tension area B that is configured according to one of the FIGS. 2B, 3A and 3B.

It may also be provided that a separate tension area B is first made with the wedge bar 10, for example, by vulcanization or by subsequent assembly (sewing, bonding, etc.) and this combination is later attached to the planar element 4, for example, sewn, glued, welded, vulcanized, etc. This simplifies manufacturing because in the respective machine a more narrow region (only the tension area B) with the vertically sticking-out wedge bar must be proceed rather than the entire planar element 4 or, respectively, conveyor belt 1 with its wider transverse extension.

To attain a sewn connection a third thread 25 penetrates the wedge bar 10 as well as the adjacent layer of the tension area B, i.e., the adjacent planar element 4 and/or the adjacent rubber strip 8 (see FIG. 2B) or the adjacent tension member 5 (see FIG. 3A, 3B) in the tension area B in multiple spaced-apart stitches S. This creates a fully circumferential wedge bar seam 26 in the tension area B extending in the longitudinal direction X or, respectively, in the transport direction F, where the stitches S of this wedge bar seam 26 preferably run approximately along a central longitudinal axis 10L of the wedge bar 10.

The wedge bar 10 itself consists of a wedge corpus, extending in the longitudinal direction X or transport direction F or, respectively, fully circumferential around the conveyor belt 1, the cross-section of the corpus being trapezoid the longer base of which lies in contact with the inner side BI of the tension region B or, according to FIG. 2A, directly transitions into the planar element 4. The wedge bar 10 is manufacture, for example, in an extrusion process from rubber or a plastic material, e.g., PVC, PU, and cut accordingly such that this can be attached, in particular, sewn, in a single circumference to the inner side of the tension area B.

According to FIG. 4A, 4B, a groove 10a is introduced in the shorter base of the trapezoid wedge bar 10 lying opposite the inner side BI of the tension region B, and the third thread 25 runs inside this groove in a sewn connection. Thus, the third thread 25 does not touch the drive roller 2 and/or pulley 3 in the operation of the conveyor belt 1 so that this can be protected against wear.

As shown in FIG. 4A, the stitches S of the wedge bar seam 26 also extend through the respective reinforcement inlay 6, 6a; 8b, 5a of the planar element 4 or, respectively, of the rubber strip 8 or, respectively, of the tension member 5, so that a high-strength sewn connection is created. To improve this even further, as shown in FIG. 4B, a reinforcement inlay 10c (fleece layer V or fabric layer G) may be embedded also in a base area 10b of the wedge bar 10 facing the inner side BI of the tension region B so that the stitches S of the wedge bar seam 26 also penetrate this making the sewn connection even more robust.

According to one embodiment, it may also be provided to combine at least one of the tension area seams 22 with the wedge bar seam 26. In that case, the first thread 21 or, respectively, the third thread 25 penetrated both the wedge bar 10 and the two reinforced polymer layers 7; 7 (folded over) or 7, 8a lying on top of one another shown in FIG. 2B. Hereby, using one one thread 21, 25 both the wedge bar 10 is attached to the inner side of the tension area B and the two polymer layers 7; 7 (folded over) or 7, 8a are connected with one another.

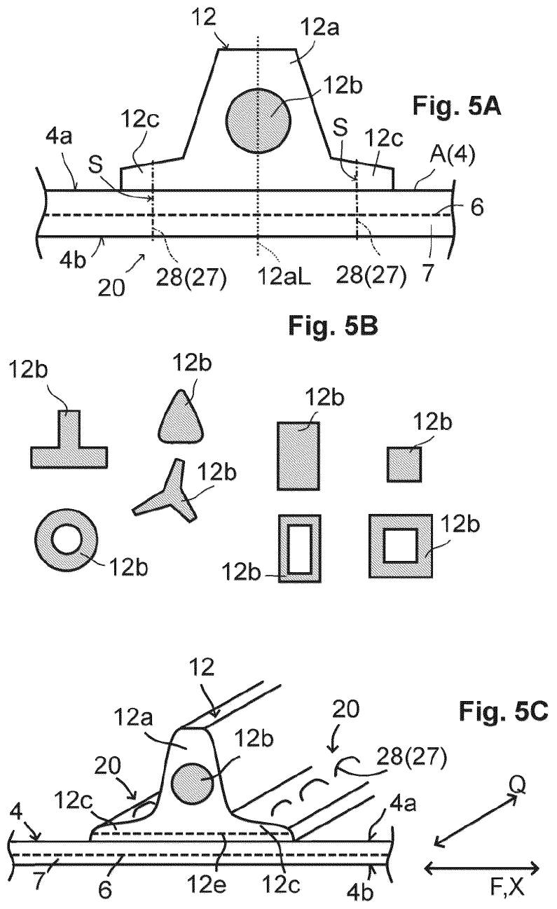

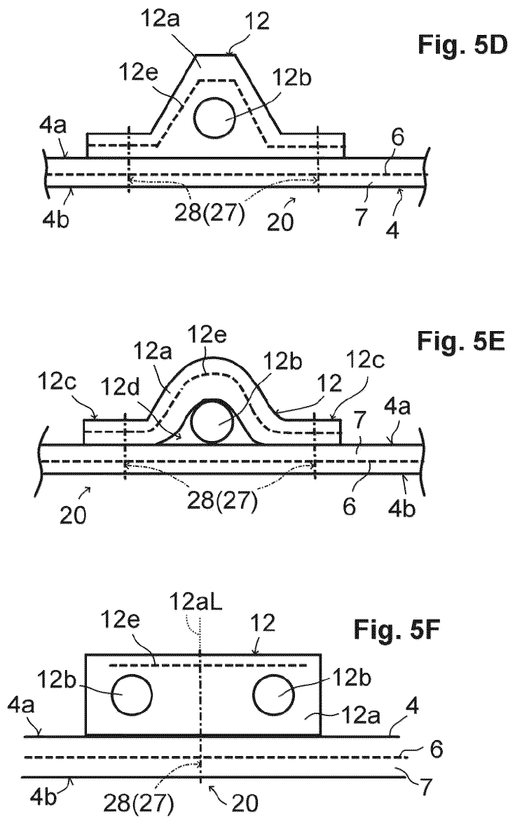

Furthermore, the conveyor belt 1 comprises entrainment slats 12 extending in the transverse direction Q that are located on the outer side 1a of the conveyor belt 1 or, respectively, the outer side 4a of the planar element 4, i.e., on the opposite side of the wedge bar 10. The entrainment slats 12 serve to carry along the goods to be conveyed lying on the outer side 1a in the transport direction F or, respectively, in the longitudinal direction X. To that end, the entrainment slats 12 are attached, in particular, also sewn, to the outer side of the accordingly reinforced planar element 4, in particular, in the entrainment region A, as shown in detail in the FIGS. 5A-5F in various embodiments.

Hereby, it may further be provided, that on the outer side 4a of the planar element 4 at least in the entrainment region A rolling inhibiting bars 13 are added that slightly stock out from the outer side 4a and are arranged every distributed across the entire surface, for example, offset against one another, as indicated in FIG. 2A for a partial area. The rolling inhibiting bars 13 each have, for example, a rounded shape, for example, sickle shape, or an angular shape, for example, triangular shape, zigzag shape, rhomboidal shape or U shape, each opening transverse to the transport direction F. Hereby, the rolling inhibiting bars 13 serve to hold the goods to be conveyed lying on top inside the entrainment region A, in particular, in the case of a conveyor belt 1 tilted in the transverse direction Q. Then, the rolling inhibiting bars 13 also opening in the transverse direction Q (towards the top) will stop the goods to be conveyed rolling along the slope in the transverse direction Q and prevent them from falling off the conveyor belt 1.

In all embodiments, the entrainment slat 12 comprises a strut-like

entrainment body 12a extending in the transverse direction Q which encloses a rod 12b essentially across the entire length of the entrainment slat 12. The rod 12b is made, for example, from fiber-reinforced plastics (GFK) or metal or a material of similar strength and has a round cross-section (see FIG. 5A) or a cross-section having another profile (see FIG. 5B). The rod 12b may be embedded into the entrainment body 12a directly during there making thereof, for example, in a vulcanization process. Alternatively, the rod 12b may be inserted, after making the entrainment body 12a, into a complementary shaped hole or a duct in the entrainment body 12a and subsequently connected there to, for example, by substance-to-substance bond.

According to the embodiments in FIGS. 5A, 5C, 5D, 5E, the inner side of the entrainment body 12a transitions towards both longitudinal sides into two bases 12c that extend as a foundation across the entire length of the entrainment slat 12. Via these bases 12c the entrainment slat 12 lies at least in contact with the planar element 4 on its outer side 4a and via these is also attached there to, preferably stitched there to. In the embodiment according to FIG. 5F, the (sewn) connection is not made via such bases 12c, as will be explained in the following. The respective entrainment slat 12 may extend laterally also beyond the entrainment region A into the tension areas B and also be connected there to accordingly.

The entrainment body 12a and the bases 12c (if existing) of the respective entrainment slat 12 are made from a rubber or a plastics material, e.g., PVC, PU, preferably in any desired vulcanization process (e.g., compression molding, transfer molding, injection molding). Hereby, the entrainment body 12a may be made in various shapes. According to FIGS. 5A, 5C and 5D, the entrainment body 12a is made trapezoid in the cross-section, where this trapezoid entrainment body 12a at its long base transitions into the bases 12c via which it is attached to the planar element 4. The rod 12b is essentially embedded in the trapezoid area.

According to FIG. 5E, the entrainment body 12a has a flat, rectangular cross-section, where the longitudinal end regions form the bases 12c which lie in contact with the planar element 4, and the middle area lying in-between is bent or shaped towards the outside so that a conduit 12d or gap is formed above the outer side 4a of the planar element 4. In the conduit 12d the rod 12b is held by clamping or by form locking. According to FIG. 5F, the entrainment body 12a is also made with a rectangular cross-section, where two rods 12b are embedded in the entrainment body 12a, and the entrainment body 12a lies laminar on the outer side 4a of the planar element 4. Preferably, however, a round cross-section (not shown) of the entrainment body 12a may be provided also.

For a sewn connection a fourth thread 27 penetrates the planar element 4 and the base 12c of the respective entrainment slat 12 resting upon it in multiple stitches S (according to FIGS. 5A, 5C, 5D, 5E) such that an entrainment seam 28 is created essentially across the entire length of the entrainment slat 12. Depending on the arrangement of the stitches S this may result in various seam shapes of the entrainment seam 28. Such an entrainment seam 28 is introduced towards both longitudinal sides into both bases 12c so as to attain a two-sided attachment of the entrainment slat 12.

As shown in FIG. 5A, the stitches S of the respective entrainment seam 28 extend also through the respective reinforcement inlay 6 of the planar element 4 so that a high-strength sewn connection is created. To improve this even further, as shown in FIG. 5C, 5D and 5E, a reinforcement inlay 12e (fleece layer V or fabric layer G) may be embedded also into the entrainment slat 12, in particular, in the region of the bases 12c, so that the stitches S of the entrainment seam 28 penetrate this also, making the sewn connection even more robust. In-between the bases 12c the reinforcement inlay 12e of the entrainment slat 12 may run through the respective entrainment body 12a below or above the rod 12b, as show by way of example in the FIGS. 5A through 5E.

According to the embodiment in FIG. 5F, the sewn connection is formed in that the fourth thread 27 in the multiple stitches S extends approximately along a central longitudinal axis 12aL of the entrainment body 12a with rectangular cross-section. Thus, only one entrainment seam 28 is provided. In This case the reinforcement inlay 12e of the entrainment slat 12 lies above the two rods 12b and is also penetrated by the entrainment seam 28. However, the reinforcement inlay 12e may also be arranged below the two rods 12b on the side of the entrainment slat 12 facing the outer side 4a of the planar element 4.

Thus, individual components of the conveyor belt 1 may be attached via threads 21, 23, 25, 27 or, respectively, seams 22, 24, 26, 28 in a simple and robust manner, allowing for a flexible use, as such a sewn connection is simple to adapt to changed arrangements or dimensions of the individual components without the need to adapt the entire manufacturing process. Hereby, it may be provided that only one or individual one of the aforementioned components are attached to the conveyor belt 1 via the respective seams 22, 24, 26, 28 while the further component(s) are attached via any suitable means of attachment, for example, by glueing, vulcanizing, molding, welding. Furthermore, the respective sewn connection may also be secured by a, for example, substance-to-substance bond.

Conveyor belts are used in many agricultural machines. They are configured to be as tough as possible so as to achieve a long service life under often rough working conditions. In particular, in the case of rakes which work at high hauling speeds the conveyor belts used as subjected to high dynamic loads due to the high working velocity as well as high bending forces due to the small deflection radii on the drive rollers and pulleys which may be provided as barrel rollers.

Comparative belts of this type comprise a planar element and entrainment slats extending in a transverse direction projecting away from an upper side or an outer side of the planar element or, respectively, of the conveyor belt. Hereby, the entrainment slats are glued or vulcanized or cast on or welded on to the upper side or the outer side of the planar element. The entrainment slats serve to carry along the transported material to be conveyed. Further, tension areas in the form of cam belts are provided at the sides of the conveyor belt via which the conveyor belt is driven. To that end, the cam belts are provided with cams projecting away from an underside or, respectively, an inner side which cams lie in contact with the drive rollers and the pulleys.

Comparative friction-type, cam-less drive of the conveyor belt to mount wedge bars on the underside or the inner side of the conveyor belt extending in the direction of transport or, respectively, in the longitudinal direction which serve to guide the conveyor belt lying in frictional contact with the drive rollers and the pulleys.

In comparative belts, the introduction of a rod within the entrainment slats arranged in the transverse direction and on the upper side or the outer side of the conveyor belt, for example, via a going through conduit or a through hole in the entrainment body, so as to increase the rigidity of the entrainment slat.

Hereby, it is a disadvantage that comparative the process of affixing the respective component, i.e., the cam belt in the tension area or the wedge bar and/or the entrainment slat, onto the pre-fabricated planar element, for example, by glueing, vulcanizing, molding, welding, is highly complex and takes a long time. Also, depending on the area of application, it may be impossible to guarantee a durability of the individual components in operation. Moreover, changes in the configuration of the conveyor belt are very complex to implement since the special shapes, for example, for the vulcanization must be intricately adapted to the new configuration complicating a flexible and cost-effective adaptation.

Some comparative belts may sew together the ends of a conveyor belt to obtain an endless circumferential conveyor belt.

It is the object of the present disclosure to provide a conveyor belt which is simple and flexible to produce while, at the same time, being highly robust or, respectively, durable therefore providing long periods of operation.

This task is solved by a conveyor belt according to claim 1. Hereby, the sub-claims specify preferred further developments.

Thus, according to the present disclosure, it is provided that in a conveyor belt for agricultural machines according to the preamble, in particular, in a draper belt for transporting goods to be conveyed in a direction of transport, a sewn connection is made, more specifically,

Variant 1: in the transverse direction (essentially perpendicular to the transport direction) extending between at least one entrainment slat or entrainment fin and a planar element in an entrainment region, to connect the at least one entrainment slat with the planar element, and/or

Variant 2: fully circumferential (in the circumferential direction) around the conveyor belt in at least one tension area which serves to absorb tension forces upon driving the conveyor belt.

Thus, the conveyor belt according to the preamble comprises at least one such entrainment region made of a preferably fully circumferential planar element, the planar element comprising a polymer layer including at least one reinforcement inlay, e.g., a fabric layer or a fleece layer/web layer (non-woven), where, preferably, a rubberized outer side (upper side) of the planar element is provided, in particular, in the entrainment region for the goods to be conveyed to rest upon and to be entrained. Hereby, the planar element is joined to be endless at will. Preferably, the at least one reinforcement inlay of the planar element is covered on both sides in the entrainment region by the polymer layer of the planar element or merely on the inside or merely on the outside by the polymer layer of the planar element.

Hereby, it may further be provided for rolling inhibiting structures or, respectively, bars to be applied onto the outside (upper side) of the planar element at least in the entrainment region which slightly project away from the outside and are arranged evenly distributed across the entire surface, for example, offset in relation to one another. The rolling inhibiting bars each have, for example, a rounded shape, for example, crescent shape, or an angular shape, for example, triangular shape, zigzag shape, diamond shape or U shape, each opening in a direction perpendicular to the transport direction. Hereby, the rolling inhibiting bars serve to retain the goods to be conveyed resting thereon in the entrainment region, in particular, in the case of a conveyor belt inclined in the transverse direction. Then, the rolling inhibiting bars also opening in the transverse direction will stop the goods to be conveyed rolling off along the slope in the transverse direction and prevent it from falling off conveyor belt.

Further, at least two, preferably fully circumferential tension areas each made of at least one polymer layer and at least one reinforcement inlay, e.g., a fabric layer or a fleece layer (non-woven), are provide, where the planar element extends in-between these tension areas. The planar element may be connected with the at least two tension areas circumferential on both sides by the sewn joint (according to Variant 2). The tension areas too are joint at will to be endless. Preferably, a tensile strength of the entrainment region in the direction of transport is smaller than a tensile strength of the respective tension area in the direction of transport because the tension area is provided to drive the conveyor belt and therefore subjected to higher tension loads, in particular, in the direction of transport.

Preferably, it may also be provided that the higher tensile strength in the direction of transport in the respective tension area is created in that
the at least one reinforcement inlay in the respective tension area is made from a material having a higher tensile strength than the material of the at least one reinforcement inlay in the entrainment region, and/or
the at least one polymer layer in the respective tension area is made from a material having a higher tensile strength than the material of the at least one polymer layer in the entrainment region. This is a simple to implement option of increasing the tensile strength.

There also may be provided more than one entrainment region or, respectively, more than one planar element and therefore also more than one tension area, in the case of a broad conveyor belt supported on drive roller and pulleys not only on the outside but also in the middle.

Further, multiple entrainment slats are provided, the entrainment slats extending on the outside of the planar element in the transverse direction, and possibly even project beyond that into the tension areas, and being connected with the planar element in the entrainment region at least between the tension areas, for example, via a sewn connection (according to Variant 1). Hereby, a (sewn) connection with the tension areas may be formed even when the ends of the entrainment slats project into these.

Hereby, preferably, it is provided for the at least one entrainment slat to be reinforced by a rod extending along the entrainment slat, preferably a rod made of glass fiber reinforced plastic or metal, the rod preferably having a round cross-section. Other cross-sections are also possible, however.

Moreover, preferably, at least one fully circumferential wedge bar is provided, where the at least one wedge bar extends on an inner side (lower side) of the respective tension area, where, preferably, the wedge bar too may be connected with the tension areas fully circumferential by means of the sewn connection (according to Variant 2). Hereby, the inner side of the tension area together with an inner side of the planar element co-forms an inner side of the conveyor belt and therefore lies opposite the outer side of the planar element.

Thus, the single general concept is to connect individual or even all components of the conveyor belt, i.e., at least one wedge bar (according to Variant 2) and/or at least one entrainment slat (according to Variant 1) and/or the at least one tension area from at least one polymer layer and at least one reinforcement inlay (according to Variant 2), via a sewn connection to the respectively adjacent component, so as to improve or to expand the characteristics (higher tensile strength, robustness, resilience) and/or functions (entrainment function, guide function) of the conveyor belt.

This alone brings about several advantages: For example, there is no need for a complex and/or lengthy connecting process such as glueing, welding, vulcanizing, molding and the costly tools associated therewith for connecting the respective component with the entrainment region and/or the tension area. By means of a sewn connection it is possible to create a highly durable and robust or, respectively, high-tensile transition between the respective component of the conveyor belt, while a seam can be made with little effort.

Also, in the case of an adaptation of the configuration of the conveyor belt needed by an adaptation of dimensions or positions of the respective components, the sewn connection can be adapted in a simple and flexible manner. Moreover, the material does not necessarily require adjustment to a heat treatment to create the connection.

In principle, however, it may nevertheless be provided that
the components that are not connected to one another by a sewn connection, instead
or the components that are connected to one another by a sewn connection, additionally are connected to one another via a substance-to-substance bond, for example, by vulcanization or glueing, to create the respective connection or, respectively, to strengthen it, or, respectively, secure it, for example, in the case of exceptionally high loads.

The following numbered clauses include embodiments that are contemplated and non-limiting:

Clause 1: Conveyor belt for agricultural machines, in particular, draper belt for transporting goods to be conveyed in a transport direction, comprising:
at least one entrainment region consisting of a planar element made from a polymer layer circumferentially running around the conveyor belt, the planar element being reinforced by at least one reinforcement inlay/layer, where an outer side of the planar element is provided as support for the goods to be conveyed;
at least two tension areas each consisting of at least one polymer layer circumferentially running around the conveyor belt, the tension areas each being reinforced by at least one reinforcement inlay and the planar element extending in-between the tension areas; and
multiple entrainment slats, the entrainment slats extending on the outer side of the planar element in the transverse direction and being connected with the planar element in the entrainment region at least between the tension areas;
   wherein at least one sewn connection is formed
in the transverse direction extending between at least one of the entrainment slats and the planar element, to connect the at least one entrainment slat with the planar element, and/or
circumferential around the conveyor belt in at least one of the tension areas.

Clause 2: Conveyor belt according to clause 1 wherein a tensile strength of the respective tension area in the direction of transport is higher than a tensile strength of the entrainment region in the direction of transport.

Clause 3: Conveyor belt according to clause 2, wherein the higher tensile strength in the direction of transport in the respective tension area is formed in that a number of reinforcement inlays in the respective tension area is larger than a number of reinforcement inlays in the entrainment region.

Clause 4: Conveyor belt according to clause 3, wherein the planar element with its at least one reinforcement inlay also protrudes into the respective tension area, where inside the polymer layer of the planar element inside the respective tension area, additionally, at least one additional reinforcement inlay is arranged flat or two-dimensional above and/or is arranged flat or two-dimensional below the reinforcement inlay so as to create a higher tensile strength in the respective tension area.

Clause 5: Conveyor belt according to clause 3, wherein the planar element with its at least one reinforcement inlay also protrudes into the respective tension area, where in the respective tension area a rubber strip is attached to the outer side and/or the inner side of the planar element to create a higher tensile strength in the respective tension area, the rubber strip having at least one reinforcement inlay which is covered on the outer side and/or the inner side by a polymer layer.

Clause 6: Conveyor belt according to clause 5, wherein the rubber strip is being attached to the planar element by means of the sewn connection circumferentially running or rotating around the conveyor belt in the respective tension area.

Clause 7: Conveyor belt according to clause 3, wherein the planar element with its at least one reinforcement inlay also protrudes into the respective tension area, the planar element being folded over onto itself in the respective tension area thereby forming a fringe so as to create a higher tensile strength in the respective tension area.

Clause 8: Conveyor belt according to clause 7, wherein the fringe is being held together by means of the sewn connection circumferentially running or rotating around the conveyor belt in the respective tension area.

Clause 9: Conveyor belt according to one of the clauses 2 or 3, wherein the respective tension area is formed by a separate tension member, the tension member being laterally attached to the planar element circumferential around the conveyor belt, the tension member comprising at least one reinforcement inlay which is covered on the outer side and/or the inner side by at least one polymer layer.

Clause 10: Conveyor belt according to clause 9, wherein the tension member being laterally attached to the planar element circumferential around the conveyor belt by means of the sewn connection circumferentially running around the conveyor belt in the respective tension area.

Clause 11: Conveyor belt according to clauses 9 or 10, wherein the at least one polymer layer is removed in certain areas on the outer side and/or the inner side in such a way that a step is formed circumferential around the conveyor belt, the edge of the planar element being applied to or inserted into the step circumferential around the conveyor belt,

wherein the sewn connection in the respective tension area is running circumferential around the conveyor belt in the area of the step, so as to attach the separate tension member onto the planar element.

Clause 12: Conveyor belt according to any one of the clauses 9 to 11, wherein the polymer layer of the planar element is removed on the outer side and/or the inner side in such a way that
a distance between the at least one reinforcement inlay of the separate tension member and the at least one reinforcement inlay of the planar element, and/or
a protrusion between the planar element and the separate tension member is minimized, in particular, being less than 4 mm.

Clause 13: Conveyor belt according to one of the above clauses, wherein the conveyor belt further comprises at least one wedge bar, the at least one wedge bar running around the conveyor belt on an inner side of the respective tension area, for guiding the conveyor belt on a drive roller and/or a pulley.

Clause 14: Conveyor belt according to clause 13, wherein the at least one wedge bar is attached to the inner side of the respective tension area by means of the sewn connection running around the conveyor belt in the respective tension area, where
the sewn connection extends along a central longitudinal axis of the respective wedge bar, and/or
the sewn connection extends through a base area of the respective wedge bar, wherein the base area is facing the inner side of the respective tension area and the respective wedge bar in the base area preferably comprises a reinforcement inlay through which also the sewn connection runs.

Clause 15: Conveyor belt according to clause 14, wherein the sewn connection extends along a central longitudinal axis through a groove which is introduced in the respective wedge bar opposite of the inner side of the respective tension area.

Clause 16: Conveyor belt according to one of the above clauses, wherein the at least one entrainment slat is reinforced by a rod extending along the entrainment slat.

Clause 17: Conveyor belt according to clause 16, wherein the rod is made of glass fiber reinforced plastics or of metal.

Clause 18: Conveyor belt according to one of the above clauses, wherein the at least one entrainment slat comprises an entrainment body extending in the transverse direction, where the at least one sewn connection for attaching the respective entrainment slat onto the planar element in the transverse direction
runs through the entrainment body, in particular, through a central longitudinal axis of the entrainment body, and/or
through at least one base adjacent to the outer side of the planar element, the entrainment body in the direction of transport transitioning into the at least one base.

Clause 19: Conveyor belt according to clause 18, wherein the entrainment body and/or the at least one base is reinforced by a reinforcement inlay through which also the sewn connection formed in the transverse direction runs, where, when a rod extending along the entrainment slat is present, the reinforcement inlay extends above or below the rod.

Clause 20: Conveyor belt according to one of the above clauses, wherein the respective sewn connection is formed by a thread which, in multiple stitches,
penetrates the at least one tension area in the transport direction, and/or
penetrates the at least one entrainment slat and the respective planar element in the transverse direction, so that a seam is formed running in the transport direction and/or in the transverse direction.

### LIST OF REFERENCE NUMERALS

1 conveyor belt
1a outer side of the conveyor belt
2 drive roller
2a end region of the drive roller 2
2b groove in the drive roller 2
3 pulley
3a end region of the pulley 3
3b groove in the pulley 3
4 planar element
4a outer side of the planar element 4
4b inner side of the planar element 4
4c fringe of the planar element 4
5 tension member
5a reinforcement inlay of the tension member 5
5b polymer layer of the tension member 5
5c step in the tension member 5
6 reinforcement inlay of the planar element 4
6a additional reinforcement inlay
7 polymer layer of the planar element 4
8 rubber strip
8a polymer layer of the rubber strip 8
8b reinforcement inlay of the rubber strip 8
9 protrusion
10 wedge bar
10a groove in the wedge bar 10
10b base area of the wedge bar 10
10c reinforcement inlay of the wedge bar 10
10L central longitudinal axis of the wedge bar 10
11 side frames in the groove 2b, 3b
12 entrainment slat
12a entrainment body
12aL central longitudinal axis of the entrainment slat 12
12b rod
12c base of the entrainment slat 12
12d conduit
12e reinforcement inlay of the entrainment slat 12
13 rolling inhibiting bars
20 sewn connection
21 first thread
22 tension area seam
23 second thread
24 transition seam
25 third thread
26 wedge bar seam
27 fourth thread
28 entrainment seam
A entrainment region
B tension area
BI inner side of the tension area B
F transport direction
G fabric layer
Q transverse direction
S stitching
V fleece layer/web layer
X longitudinal direction
Z vertical direction

1. A conveyor belt for agricultural machines, in particular, draper belt for transporting goods to be conveyed in a transport direction, comprising:
at least one entrainment region comprising a planar element made from a polymer layer circumferentially running around the conveyor belt, the planar element being reinforced by at least one reinforcement inlay, where an outer side of the planar element is provided as support for the goods to be conveyed;
at least two tension areas each comprising at least one polymer layer circumferentially running around the conveyor belt, the tension areas each being reinforced by at least one reinforcement inlay and the planar element extending in-between the tension areas; and
multiple entrainment slats, the entrainment slats extending on the outer side of the planar element in the transverse direction and being connected with the planar element in the entrainment region at least between the tension areas;
wherein the at least one sewn connection is formed
in the transverse direction extending between at least one of the entrainment slats and the planar element, to connect the at least one entrainment slat with the planar element, and/or
circumferential around the conveyor belt in at least one of the tension areas.

2. The conveyor belt of claim 1, wherein a tensile strength of the respective tension area in the direction of transport is higher than a tensile strength of the entrainment region in the direction of transport.

3. The conveyor belt of claim 2, wherein the higher tensile strength in the direction of transport in the respective tension area is formed in that a number of reinforcement inlays in the respective tension area is larger than a number of reinforcement inlays in the entrainment region.

4. The conveyor belt of claim 3, wherein the planar element with its at least one reinforcement inlay also protrudes into the respective tension area, where inside the polymer layer of the planar element inside the respective tension area, additionally, at least one additional reinforcement inlay is arranged flat above and/or is arranged flat below the reinforcement inlay so as to create a higher tensile strength in the respective tension area.

5. The conveyor belt of claim 3, wherein the planar element with its at least one reinforcement inlay also protrudes into the respective tension area, where in the respective tension area a rubber strip is attached to the outer side and/or the inner side of the planar element to create a higher tensile strength in the respective tension area, the rubber strip having at least one reinforcement inlay which is covered on the outer side and/or the inner side by a polymer layer.

6. The conveyor belt of claim 5, wherein the rubber strip is being attached to the planar element by means of the sewn connection circumferentially running around the conveyor belt in the respective tension area.

7. The conveyor belt of claim 3, wherein the planar element with its at least one reinforcement inlay also protrudes into the respective tension area, the planar element being folded over onto itself in the respective tension area thereby forming a fringe so as to create a higher tensile strength in the respective tension area.

8. The conveyor belt of claim 7, wherein the fringe is being held together by means of the sewn connection circumferentially running around the conveyor belt in the respective tension area.

9. The conveyor belt of claim 2, wherein the respective tension area is formed by a separate tension member, the tension member being laterally attached to the planar element circumferential around the conveyor belt, the tension member comprising at least one reinforcement inlay which is covered on the outer side and/or the inner side by at least one polymer layer.

10. The conveyor belt of claim 9, wherein the tension member being laterally attached to the planar element circumferential around the conveyor belt by means of the sewn connection circumferentially running around the conveyor belt in the respective tension area.

11. The conveyor belt of claim 9, wherein the at least one polymer layer is removed in certain areas on the outer side and/or the inner side in such a way that a step is formed circumferential around the conveyor belt, the edge of the planar element being applied to or inserted into the step circumferential around the conveyor belt, wherein the sewn connection in the respective tension area is running circumferential around the conveyor belt in the area of the step, so as to attach the separate tension member onto the planar element.

12. The conveyor belt of claim 9, wherein the polymer layer of the planar element is removed on the outer side and/or the inner side in such a way that
a distance between the at least one reinforcement inlay of the separate tension member and the at least one reinforcement inlay of the planar element, and/or
a protrusion between the planar element and the separate tension member is minimized, in particular, being less than 4 mm.

13. The conveyor belt of claim 1, wherein the conveyor belt further comprises at least one wedge bar, the at least one wedge bar running around the conveyor belt on an inner side of the respective tension area, for guiding the conveyor belt on a drive roller and/or a pulley.

14. The conveyor belt of claim 13, wherein the at least one wedge bar is attached to the inner side of the respective tension area by means of the sewn connection running around the conveyor belt in the respective tension area, where
the sewn connection extends along a central longitudinal axis of the respective wedge bar, and/or
the sewn connection extends through a base area of the respective wedge bar, wherein the base area is facing the inner side of the respective tension area and the respective wedge bar in the base area comprises a reinforcement inlay through which also the sewn connection runs.

15. The conveyor belt of claim 14, wherein the sewn connection extends along a central longitudinal axis through a groove which is introduced in the respective wedge bar opposite of the inner side of the respective tension area.

16. The conveyor belt of claim 1, wherein the at least one entrainment slat is reinforced by a rod extending along the entrainment slat.

17. The conveyor belt of claim 16, wherein the rod is made of glass fiber reinforced plastics or of metal.

18. The conveyor belt of claim 1, wherein the at least one entrainment slat comprises an entrainment body extending in the transverse direction, where the at least one sewn connection for attaching the respective entrainment slat onto the planar element in the transverse direction
runs through the entrainment body, and/or
through at least one base adjacent to the outer side of the planar element, the entrainment body in the direction of transport transitioning into the at least one base.

19. The conveyor belt of claim 18, wherein the entrainment body and/or the at least one base is reinforced by a reinforcement inlay through which also the sewn connection formed in the transverse direction runs, where, when a rod extending along the entrainment slat is present, the reinforcement inlay extends above or below the rod.

20. The conveyor belt of claim 1, wherein the respective sewn connection is formed by a thread which, in multiple stitches,
penetrates the at least one tension area in the transport direction, and/or
penetrates the at least one entrainment slat and the respective planar element in the transverse direction, so that a seam is formed running in the transport direction and/or in the transverse direction.
